(19) United States
(12) Patent Application Publication
(10) Pub. No.: US 2026/0258916 A1
(43) Pub. Date: Sep. 3, 2026

(54) APPARATUS, METHOD, AND SYSTEM FOR MOBILE, TEMPORARY, OR SUPPLEMENTAL LIGHTING

(71) Applicant: Musco Corporation, Oskaloosa, IA (US)

(72) Inventors: James F. Marshall, Oskaloosa, IA (US); James A. Whitson, Oskaloosa, IA (US); Jakob D. Hanson, Oskaloosa, IA (US); Andrew D. Mullen, Mystic, IA (US); Eric D. Van Gorp, Knoxville, IA (US)

(73) Assignee: Musco Corporation, Oskaloosa, IA (US)

(21) Appl. No.: 18/873,001

(22) PCT Filed: Sep. 12, 2023
(86) PCT No.: PCT/US2023/032482

§ 371 Date: Dec. 9, 2024

Related U.S. Application Data
(60) Provisional application No. 63/405,570, filed on Sep. 12, 2022.

(51) Int. Cl. F21L 14/04; F21V 14/02; F21V 19/00; F21V 19/02; F21V 21/14; F21V 21/15; F21V 21/22; F21V 21/26; F21V 21/30; F21W 131/105; F21Y 107/50; F21Y 107/80; F21Y 115/10

(52) U.S. Cl. CPC F21L 14/04; F21V 14/025; F21V 21/145; F21V 21/15; F21V 21/22; F21V 21/26; F21V 21/30; F21V 19/003; F21V 19/02; F21W 2131/105; F21Y 2107/50; F21Y 2107/80; F21Y 2115/10

(57) ABSTRACT

Discussed herein are a variety of lighting and special effects apparatuses elevated and suspended from adjustable crane/boom assemblies to form a mobile lighting system. Said system offers improvements in mobile lighting and special effects apparatuses; improvements in functionality and adjustment of cranes, booms, jibs and/or rack systems; improvements in functionality and selectability of lighting effects for mobile lighting systems; and improvements in storage on a trailer or vehicle without impacting load balance.

### TECHNICAL FIELD

The present disclosure generally relates to mobile, temporary, or supplemental lighting systems. More specifically, the present disclosure relates to a variety of lighting devices and related apparatuses elevated and supported or suspended from mobile cranes or other adjustable, elevating devices. More specifically still, the present disclosure relates to improvements in mobile lighting devices and related apparatuses, improvements in functionality and adjustment of cranes, booms, and/or jibs, improvements in functionality and selectability of lighting effects for mobile lighting systems, and improvements in methods and equipment design to improve storage on a trailer or vehicle without negatively affecting load balance.

### BACKGROUND

Mobile lighting systems are known in the industry of temporary or supplemental lighting and may be useful for providing for such things as nighttime lighting of sporting events, primary and background lighting for motion pictures, supplemental lighting for televised events, and similar scenarios. To date, most mobile lighting systems employ some number of high wattage, high intensity discharge (“HID”) lighting fixtures-see, for example, U.S. Pat. No. 4,423,471 (the '471 patent) incorporated by reference herein in its entirety. More specifically, FIG. 1 depicts a previous lighting system 50 that may a lighting application 10 at a site 20 or a venue (e.g., a stadium, a field, etc.) using HID lighting fixtures 60. While mobile lighting systems such as those described in the '471 patent are very effective, the HID technology is becoming both outdated and hard to source. Thus, there is room for improvement in the field of mobile lighting systems.

### SUMMARY

With the advent of newer lighting technologies such as light-emitting diode (“LED”) technology, there is an opportunity to add value to mobile lighting systems. Not only do LEDs come in an array of perceivable colors with near-instant on, off, and dimming capabilities, LEDs can be paired with other apparatuses (e.g., sound systems) for special effects or otherwise tailored (e.g., in the red/blue spectrum) for a variety of lighting effects and applications (e.g., accelerated horticultural growth). When included in a mobile lighting system, such LED technology lends itself to applications that may not be suitable for an HID mobile lighting system, such as targeted turf repair as is described in U.S. Patent Application Publ. No. 2023/0172121A1 (the '121 publication) incorporated by reference herein in its entirety.

It is therefore an object, feature, advantage, or aspect of the present disclosure to improve over the state of the art and/or address problems, issues, or deficiencies in the art.

Envisioned is an LED mobile lighting system adaptable to include lighting fixtures of a variety of shapes, sizes, weights, wind loading, and functionality. A hydraulically-powered boom portion adjustable in at least two axes is paired with a hydraulically powered jib portion adjustable at multiple pivot points so to allow for a wide range of adjustability in three axes.

Further objects, features, advantages, or aspects of the present disclosure may include one or more of the following:
customized size and shape of the boom and jib portions to allow for (i) compact packing/storage arrangement for a standard over-the-road vehicle or trailer, and (ii) storage of electrical components and enclosure to power the lighting fixtures, while still allowing for (iii) folding and storage of the rack, lighting fixtures, boom and jib portions, etc., to keep a balanced load on said vehicle or trailer, and/or to provide secure storage that prevents or minimizes damage to such components that might arise due to travel over uneven terrain, for example;
customized size, shape, and adjustability of one or more structures such as crossarms or racks to accommodate lighting fixtures of differing size, shape, form factor, and aiming needs; and
means for achieving said aiming in situ (e.g., in its elevated and extended position) from a control position proximate the vehicle or trailer.

A mobile lighting system for illuminating an area according to an embodiment of the present disclosure may comprise a mobile support system (e.g., may take the form of a trailer portion, etc.) that is configured to be transported to a lighting location by a motorized vehicle portion (e.g., may take the form of a truck cab, etc.) detachably coupled thereto, a boom portion (may also be referred to as a crane portion) having a first end and a second end, the first end being pivotally mounted to the mobile support system along a horizontal axis; a jib portion operably coupled to the second end of the boom portion, a lighting rack operably coupled to the jib portion, the lighting rack comprising an array of LED lighting components (e.g., may take the form of a plurality of LED light fixtures), a hydraulic system disposed on a supported surface of the mobile support system, the hydraulic system may be aligned generally parallel to the longitudinal axis of the mobile support system, the hydraulic system being configured to move the boom portion and the jib portion from a transportation mode (may also be referred to as a storage mode) of the mobile lighting system to a deployed mode (may also be referred to as an operating mode) of the mobile lighting system.

Also, an electrical power system may be disposed on a supported surface of the mobile support system, the electrical power system being configured to provide electrical power to at least the array of LED lighting components of the lighting rack.

In some embodiments, at least a portion of the hydraulic system and/or the electrical power system are housed within two rows of containers/cabinets mounted or in the rear cabinet on the supported surface of the mobile support system on either side of the generally longitudinal axis of the mobile support system.

In some embodiments, the transportation mode includes having the jib portion and the lighting rack being disposed beneath the boom portion in a generally horizontal configuration, with the jib portion, the lighting rack, and the boom portion being positioned between the two rows of cabinets mounted on the supported surface of the mobile support system to provide support and protection thereto.

A lighting rack for a mobile lighting system according to another embodiment of the present disclosure may comprise a first vertical member and a second vertical member, a first crossarm extending from the first vertical member, a second crossarm extending from the second vertical member, a first secondary crossarm operably connecting the first crossarm to the second crossarm that extends at a first oblique angle in a horizontal plane relative to the first crossarm, a first LED light fixture operable connected to the first crossarm, and an actuation means for rotating the first LED light fixture about a first vertical axis and a first horizontal axis.

A method of controlling a mobile lighting system, the method comprising aiming the lighting system, and monitoring for unsafe wind conditions or other adverse weather conditions.

These and other objects, features, advantages, or aspects of the present disclosure will become more apparent with reference to the accompanying specification, drawings, and claims.

### BRIEF DESCRIPTION OF DRAWINGS

From time-to-time in this description, reference will be taken to the drawings which are identified by figure number and are summarized below.

FIG. 1 illustrates a typical lighting application in which a state-of-the-art mobile lighting system is used to provide mobile or otherwise temporary lighting of a venue.

FIG. 2 illustrates FIG. 1 as modified according to aspects of the present disclosure.

FIG. 3A is a right side view of the mobile lighting system 100 of FIG. 2 with the outriggers shown in a support position and the boom, crane jib and lights shown in a stowed position.

FIG. 3B is a left side view of the mobile lighting system of FIG. 3A.

Figure depicts a mobile lighting system 100 similar to that of FIG. 3A as it would appear in a transport mode, e.g., when traveling to a site 20 with the outriggers also shown in a stowed position.

FIG. 3D illustrates the trailer of the mobile lighting system 100 of FIG. 3B shown in isolation.

FIG. 3E is a rear perspective view of the trailer of FIG. 3D revealing the corridor between the left and right banks of equipment/cabinets.

FIG. 3F is an enlarged perspective view of the trailer of FIG. 3E.

FIG. 4 illustrates a side view of mobile lighting system 100 as it would appear when partially extended and pivoted at point B (e.g., midpoint through its travel).

FIG. 5 illustrates a side view of mobile lighting system 100 as it would appear when partially extended, e.g., when lighting a smaller scale venue such as a movie set.

FIG. 6 illustrates a side view of mobile lighting system 100 as it would appear when fully extended, e.g., when lighting a larger scale venue (such as a site 20 (e.g., a stadium) shown in FIG. 2).

FIG. 7 illustrates a side view of mobile lighting system 100 as it would appear in a service mode, e.g., when switching out LED lighting fixtures (see, for example, FIG. 14-16).

FIG. 8A is a right side view detailing a jib assembly 300; note that for clarity all other components of the mobile lighting system 100 have been placed in broken lines.

FIG. 8B is a left side view of the jib assembly 300, and the mobile lighting system of FIG. 8A.

FIG. 9A illustrates Detail A of FIG. 8A of the jib assembly 300; note that for clarity, all portions of mobile lighting system 100 shown in broken lines in FIG. 8A have been omitted. The portion of the jib assembly for attachment to the light rack is shown.

FIG. 9B depicts Detail B of FIG. 8B with the portion of jib assembly 300 for attachment to the boom assembly shown; note that for clarity, all portions of mobile lighting system 100 shown in broken lines in FIG. 8B have been omitted.

FIG. 10A illustrates a rear perspective view of the mobile lighting system, providing an overview of components of the power/storage means 600.

FIG. 10B illustrates a detailed side view of components contained in rear enclosure 604 of the power storage means 600 shown in isolation.

FIG. 10C illustrates a detailed side view of components contained in one of the two side enclosures 602 of the power storage means 600.

FIG. 11 illustrates a perspective view of the rack system 400 shown in isolation.

FIG. 12A illustrates Detail C of FIG. 11.

FIG. 12B illustrates an alternative view of Detail C of FIG. 11.

FIG. 13 is a perspective view of a single instance of three lights shown in isolation from a rack system similar to that of FIGS. 11, 12A, and 12B but having different rotating mechanisms for rotating the lights about a vertical axis. As can be seen in FIG. 13, all three lights are rotatable about a vertical axis, and a horizontal axis, providing the ability for all three lights to face in a different direction from each other.

FIG. 14 illustrates a plurality of so-called grow lights 420A used in the rack system 400 of the mobile lighting system 100, which may be used in horticultural applications, for example, such as suggested by the '121 publication.

FIG. 15 illustrates a plurality of general purpose (e.g., typically white light, but possibly also colored light) LED lighting fixtures 420B used in the rack system 400 of the mobile lighting system 100.

FIG. 16A is a detailed front perspective image of an exemplary lighting fixture 420B that may be used in the rack system 400 of FIG. 15. An exemplary releasable placement of a camera 430 for potential use in aiming of the lighting fixture is also shown.

FIG. 16B is an alternative perspective view of the image of FIG. 16A.

FIG. 16C is an enlarged rear image of the lighting fixture and camera of FIGS. 16A and 16B, also showing the exemplary releasable placement of a camera 430 for potential use in aiming of the lighting fixtures 420B more clearly.

FIG. 17 illustrates one possible method of transporting and operating mobile lighting system 100 to provide temporary lighting from a staging area 30 or other temporary position.

FIG. 18 illustrates sub-method steps associated with method step 705 of FIG. 17 for aiming lighting fixtures in accordance with embodiments of this disclosure.

FIG. 19 depicts a front perspective view of a jib assembly, and a light rack assembly configured according to another embodiment of the present disclosure.

FIG. 20 illustrates the light rack assembly of FIG. 19 shown by itself.

FIG. 21 is an enlarged alternate perspective view of the light rack assembly of FIG. 20 showing the top portion thereof in greater detail.

FIG. 22 is an enlarged view of the top left instance and top center instance of yoke members of the light rack assembly with the light fixtures removed.

FIG. 23 is an enlarged view of the top rotating mechanism for the top left instance of the yoke in FIG. 22.

FIG. 24 is a perspective view of another embodiment of a jib assembly as employed in FIG. 19. The jib assembly is shown in the extended state whereas the jib assembly in FIGS. 9A and 9B are shown in a retracted, stored, or transported state.

FIG. 25 is a side view of the jib assembly of FIG. 24.

FIG. 26 is an enlarged side view of the rack attachment end of the jib assembly of FIG. 25.

FIG. 27 is an enlarged side view of the boom attachment end of the jib assembly of FIG. 25.

FIG. 28 contains a method of controlling a mobile lighting system.

### DETAILED DESCRIPTION

### A. Overview

To further an understanding of the present disclosure, specific exemplary embodiments according to the present disclosure will be described in detail. Frequent mention will be made in this description to the drawings. Reference numbers will be used to indicate certain parts in the drawings, and reference letters will be used to indicate direction/angle/degree of pivoting/adjustment. Unless otherwise stated, the same reference numbers will be used to indicate the same parts throughout the drawings, and the same reference letters will be used to indicate the same pivot/adjustment points throughout the drawings. Further, similar reference numbers (e.g., 702, 802, 902, 1002, 1102) will be used to indicate similar parts or functionality between embodiments. Reference numbers followed by letters (e.g., 100, 100a) may denote the same or similar features that may be symmetrical to each other, etc.

Regarding terminology, there are a number of terms used more-or-less interchangeably herein, whether in the singular or plural; for example, “means”, “apparatus”, “devices”, “portions”, “structures”, and “components”, as well as “assemblies”, “systems”, and “means” (“means” can be used for discrete elements, as well as a combination of elements), and “enclosure” and “cabinet”. Unless specifically stated herein, use of one term over another is not intended to purport any limitations. Further, the term “pivot”, “pivotable”, and the like is sometimes used interchangeably with “adjust”, “adjustable”, and the like. It is to be understood that pivoting generally describes a rotational-type adjustment whereas a generic “adjustment” could be rotational or more vector based-specific examples, as well as reference letters, have been provided herein for context. Also, terms such as “having”, “including”, “with”, etc. or forms thereof are to be interpreted as being open, not limiting the parts of a structure that may be added to that structure.

Lastly regarding terminology, reference has been given herein to such industry terms as “crane”, “boom”, “jib”, and “rack” it can be appreciated that these terms are well known in the industry and so no definitions are provided herein. That being said, it is of note that some industry standards require a “crane” to include some form of a winch; no winch is included in the embodiments described and illustrated herein. As such, the term “light tower” may in some situations be considered more appropriate and that any instance of “crane” used herein should be interpreted to encompass the term “light tower”. Likewise, industry terms relating to the nature and purpose of lighting such as “mobile”, “temporary”, and “supplemental” are well understood, and so no definitions are provided herein, and it is to be understood that aspects of the present disclosure are not limited to any one term.

### B. Exemplary Apparatus Embodiment 1

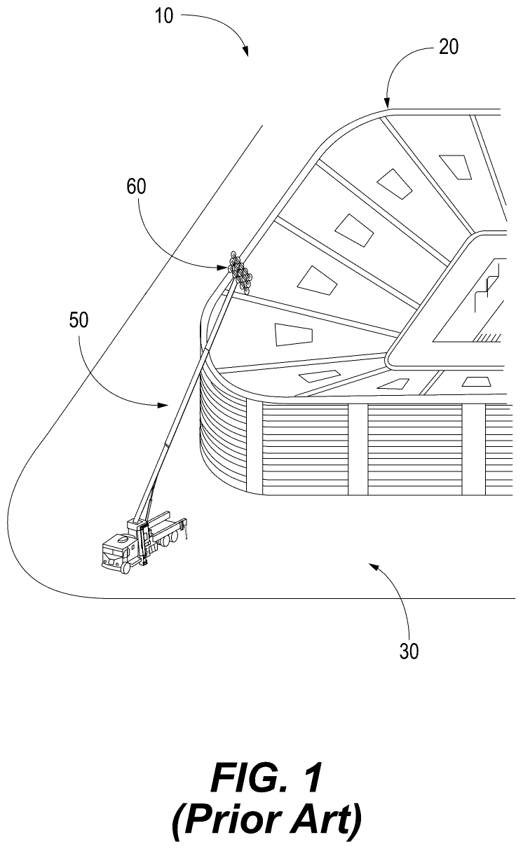

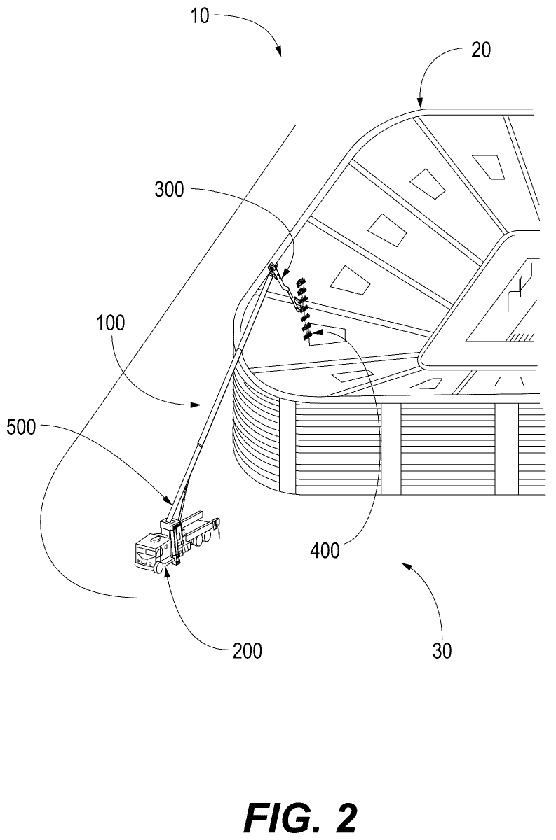

The exemplary embodiment envisions a mobile lighting system 100 including (i) means for mobility 200, (ii) a trailer-mounted crane/adjustable boom assembly 500, (iii) adjustable jib assembly 300, (iv) rack system 400, and (v) associated power/storage means 600 which can be adapted for a variety of (vi) LED or other lighting and special effects apparatuses. Aspects of the present disclosure (FIG. 2) as compared to state-of-the-art mobile lighting systems (FIG. 1) permit a wider range of perceivable colors, faster on/off/dimming capabilities, and increased adjustability/aiming options-which allows for enhanced lighting of a site 20 (may take the form of any venue such as a stadium, a field, a racetrack, a roadway, etc.) at a lighting application 10 from a proximate position or staging area 30 (e.g., a parking lot) that can be readily removed after the need for lighting or theatrical or other effects has passed.

A more specific exemplary embodiment, utilizing aspects of the generalized example described above, will now be described according to a number of technical features, any of which could be combined in any number of ways to produce mobile lighting system 100 of FIG. 2.

### Feature 1—Mobility Means and Trailer-Mounted Apparatuses

As can be seen from prior art approaches in FIG. 1 and the aforementioned '471 patent, mobility means have historically included some form of vehicle with a flat surface for mounting devices thereupon. Of course, in practice, this can include a vehicle towing a trailer or a vehicle with an integrated bed, or a container which is shipped and placed-there are a number of options and alternatives. However, one specific embodiment is presently described.

### Feature 1a: Mobility Means 200

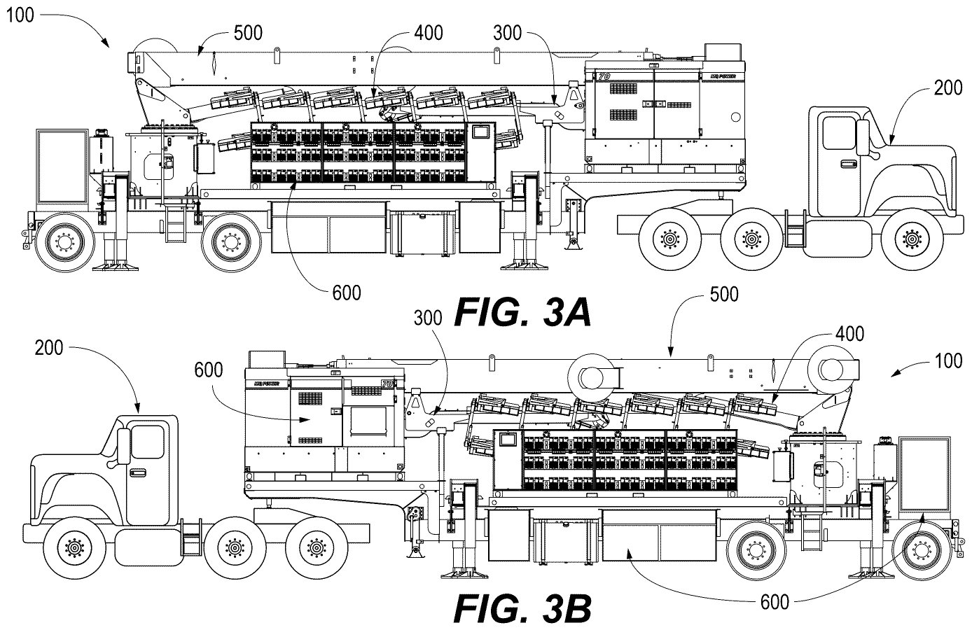

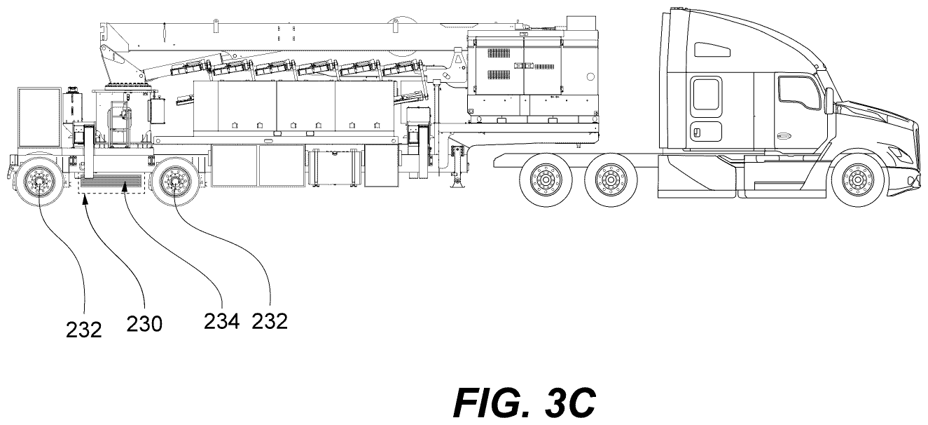

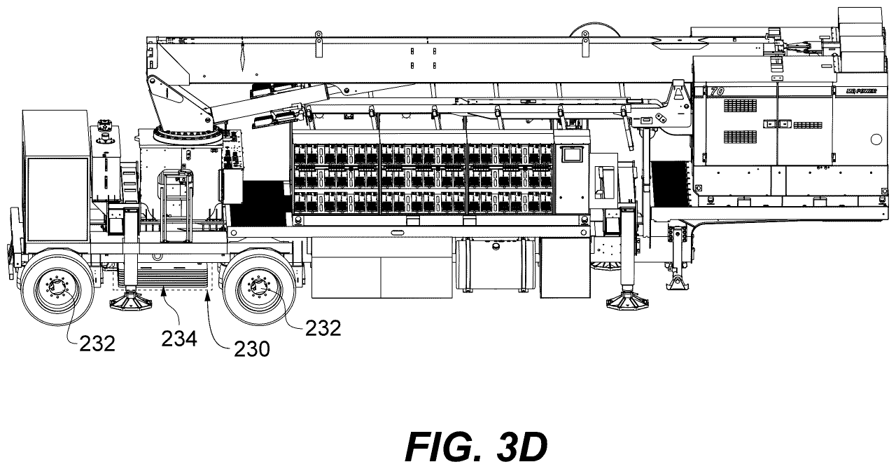

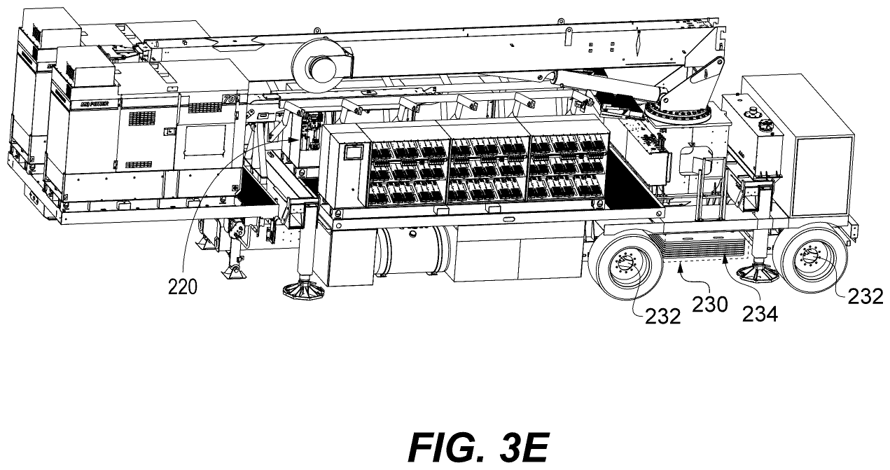

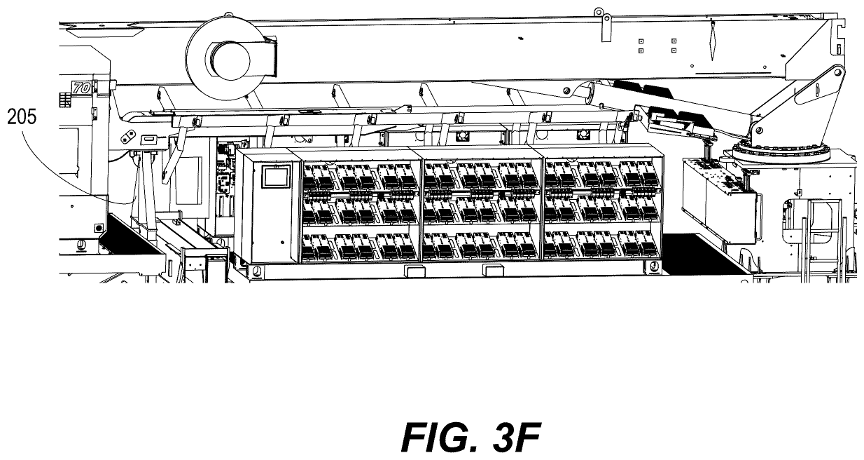

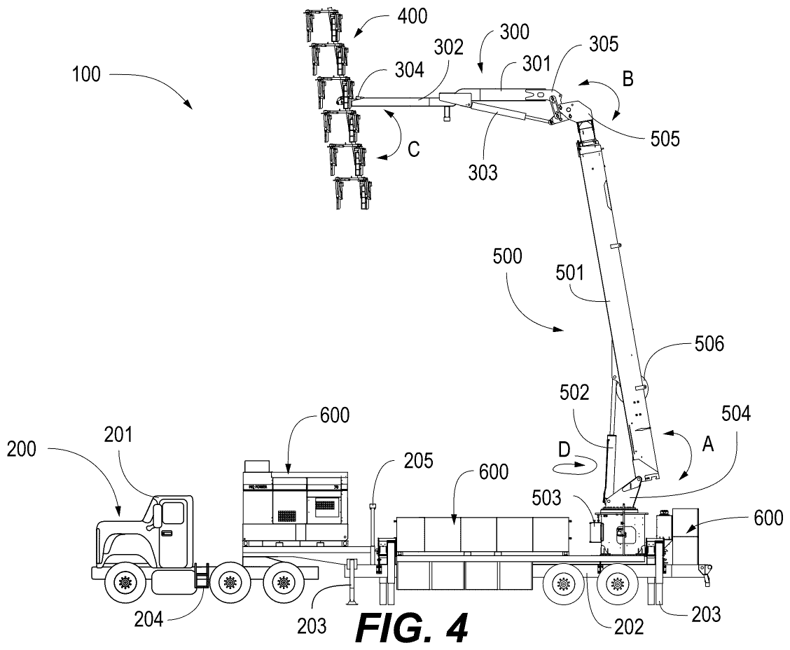

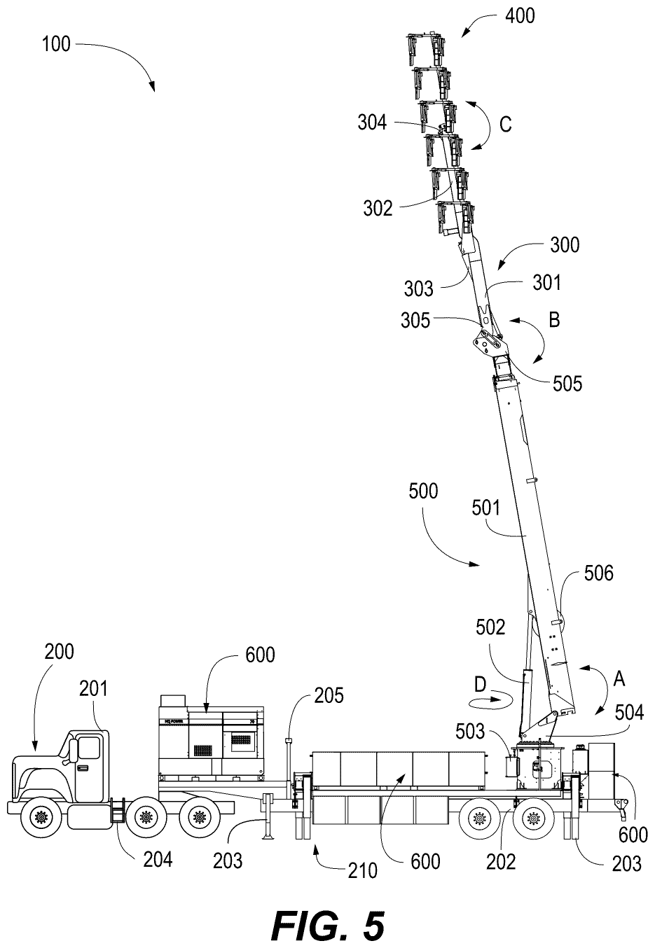

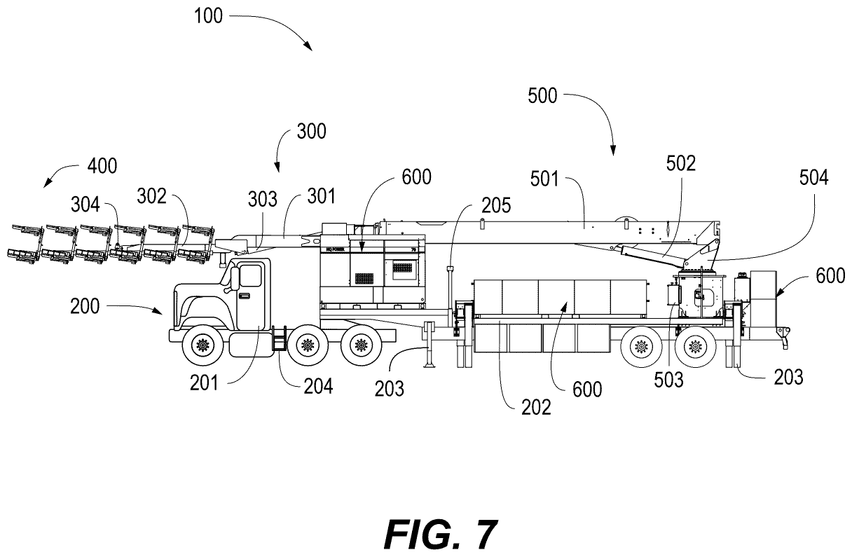

As is perhaps best seen in FIGS. 4, 5, and 7, mobility means 200 generally includes a truck 201 (here, a standard over-the-road semi-tractor) and a trailer 210 (here, a drop deck trailer in the examples shown) with associated frame rails 202, outriggers 203, a number of access points 204, and a number of stability points 205 designed to stabilize jib assembly 300, rack system 400, and/or boom assembly 500 when mobility means 200 is in transport mode (FIG. 3A-3C). It should be noted that mobility means 200 may comprise a truck 201 that includes a long support portion similar to the function of trailer 210 (e.g., an integral trailer portion of truck 201 in some embodiments). In the embodiments illustrated and described in this disclosure, mobility means 200 comprises a trailer 210 that is releasably coupled to truck 201 and which may be uncoupled from truck 201 when located at lighting site 20, for example. Truck 201 may, for example, leave site 20 during the event for which lighting is desired, and may return upon completion of the event to be coupled to trailer 210 for moving the mobility means to its next destination, for example. Here, truck 201 may be a typical semi-truck, frame rails 202 of trailer 210 may be on the order of 33 feet long, and mobile lighting system 100 can be on the order of about 13 feet tall when positioned on trailer 210 in transport mode, although this could differ for different applications without departing from the scope of the present disclosure.

FIG. 3D-3F show additional details of trailer 210 of mobility means 200 (uncoupled from truck 201 in these figures). FIG. 3D shows a placement of outriggers 203 relative to other elements of trailer 210, for example. FIG. 3E is a perspective view of trailer 210 showing an arrangement of power/storage means 600 that provides a “corridor” 220 generally along the centerline of trailer 210 in which to securely stow portions of any or all of the jib assembly 300, rack system 400, and/or boom assembly 500. The “corridor” for storage is generally formed by the placement of two rows of cabinets containing portions of power/storage means 600 on the left and right sides of trailer 210, for example, with corridor 220 formed therebetween. In some embodiments, one or more stability points 205 may be disposed in corridor 220 (e.g., at a forward portion of corridor 220, as shown) to securely hold jib assembly 300 and/or rack system 400 in place (e.g., folded under boom assembly 500) when in the transport mode, for example. More specifically, the lighting rack may be disposed at least partially in the corridor when in the transportation mode.

### Feature 1b: Crane/Adjustable Boom Assembly 500

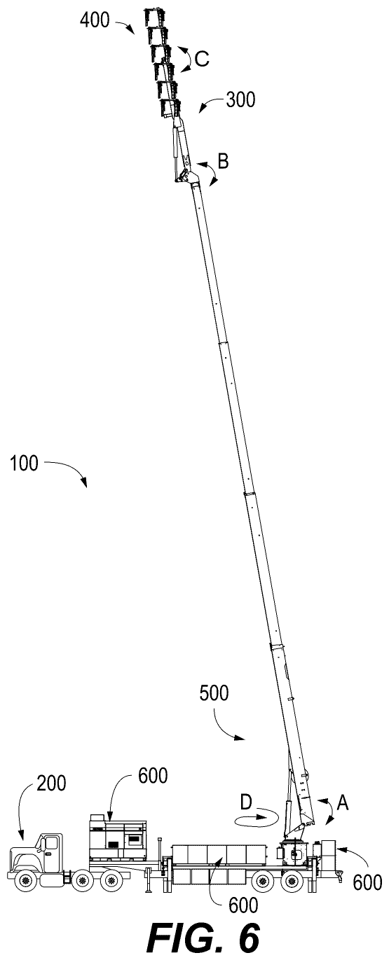

In the exemplary embodiments illustrated in FIGS. 4-7 , a model National 8100DU boom truck crane available from Manitowoc, Milwaukee, WI, USA is used, though this is by way of example and not by way of limitation. For example, a swing seat-style boom truck may be used, or even a standalone (e.g., not trailer mounted) crane/boom assembly could be used and not depart from aspects according to the present disclosure. In some embodiments, boom assembly 500 may be modified from what is commercially available; for example, the winch has been removed from the illustrated embodiments herein, and upper and lower sheave cases removed at distal point 505 (e.g., to make room for adjustable jib assembly 300), though this is by way of example and not by way of limitation. Boom assembly 500 comprises a main extending body 501, which is pivotable and/or rotatable in a first plane on the order of 360 degrees about a generally vertical axis (pivot point D), and adjustable in a second plane on the order of- 10 degrees to 80 degrees (adjustment point A). Other components of boom assembly 500 comprise a proximate connection device 504 which connects body 501 to a turret which includes a control panel 503 (which may also control outriggers 203), a hose reel 506 to supply hydraulic power to distal connection point 505, and means 502 for extending main body 501, e.g., longitudinally and/or telescopically (see FIG. 6).

In practice, assembly 500 is designed such that (i) it can be articulated in any direction in a horizontal plane (e.g., 360 degrees about pivot point D), (ii) it has a wide range of adjustability in a vertical plane (see adjustment point A), and (iii) it can be readily controlled from one or more locations on mobility means 200.

### Feature 1c: Adjustable Jib Assembly 300

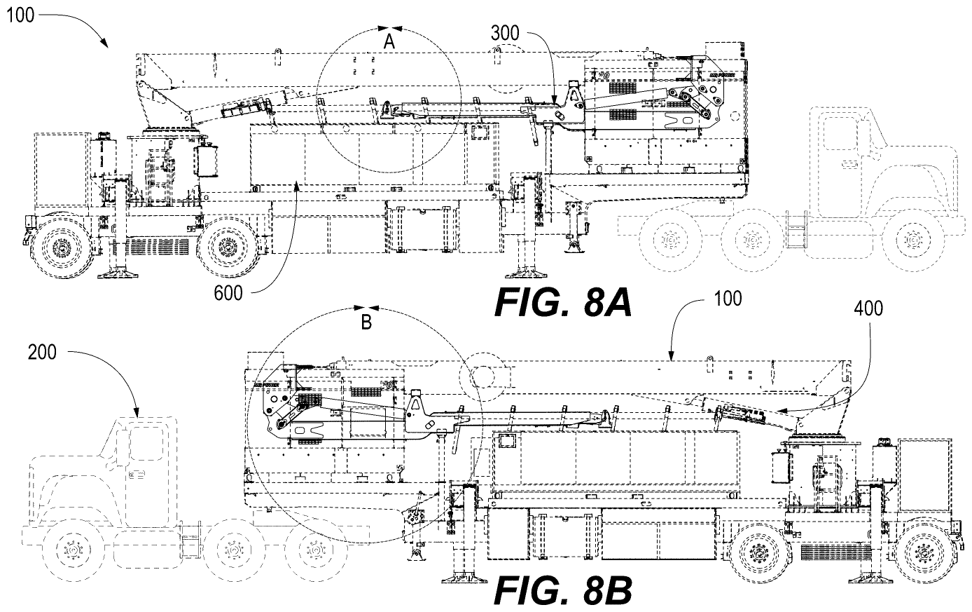

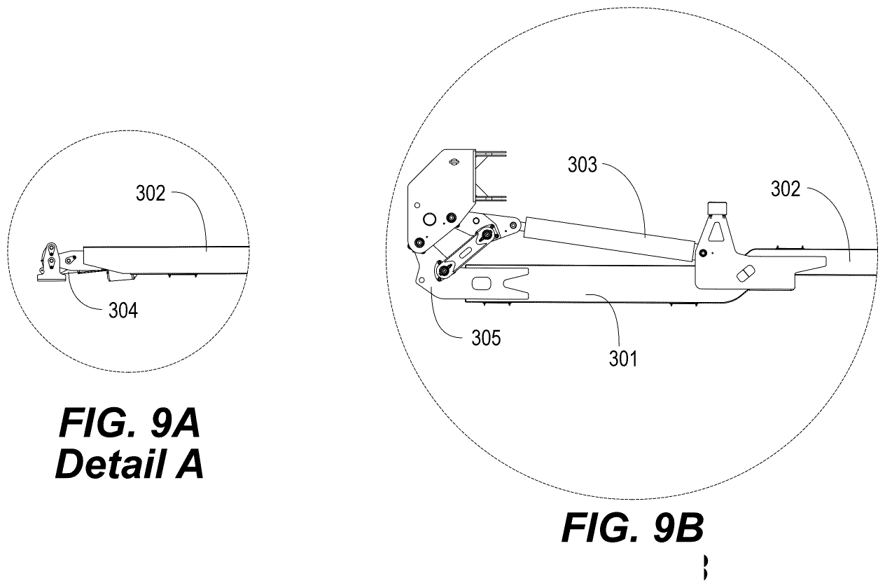

As is perhaps best seen from FIG. 4-7, jib assembly 300 may be operably coupled to adjustable boom assembly 500 at a proximal end of jib assembly 300, and jib assembly 300 may be operably coupled to rack system 400 at a distal end of jib assembly 300, and generally includes a two-part body (see first member 301, and second member 302) (e.g., to clear power/storage means 600 when in a transport or service mode), means 303 for articulating the first member 301 and/or the second member 302 (with tip loading on the order of 1800 lbf and a length on the order of 18 feet), and pinned adapters 305 and 304 for operably coupling the aforementioned jib assembly 300 to adjustable boom assembly 500 and rack system 400, respectively. The relative placement of jib assembly 300, adjustable boom assembly 500, and rack system 400, can be seen in FIG. 8A-8B when these elements are in the transport mode of mobility means 200. FIG. 9A-9B show enlarged details of pinned adapters 304 and 305 for operably coupling jib assembly 300 to rack system 400 and adjustable boom assembly 500, respectively.

In practice, jib assembly 300 is designed such that (i) any lighting fixture can be pinned to assembly 300 even in transport mode (reducing onsite installation and increasing operator safety), (ii) it can be adjusted on the order of 0 to 180 degrees in a vertical plane relative to adjustable boom assembly 500 (see pivot point B, FIGS. 4-6), (iii) it can adjust rack system 400 on the order of 0 to 180 degrees (see pivot point C, FIGS. 4-6), and (iv) because of the aforementioned adjustability, jib assembly 300 can be angled so that it is positioned under boom assembly 500 (e.g., rather than to the side) when in transport or service modes (which allows for both compact packing to ensure over-the-road transport and a balanced load on mobility means 200).

### Feature 1d: Generators, Cabinets, Power Regulating Devices, and Control Means 600

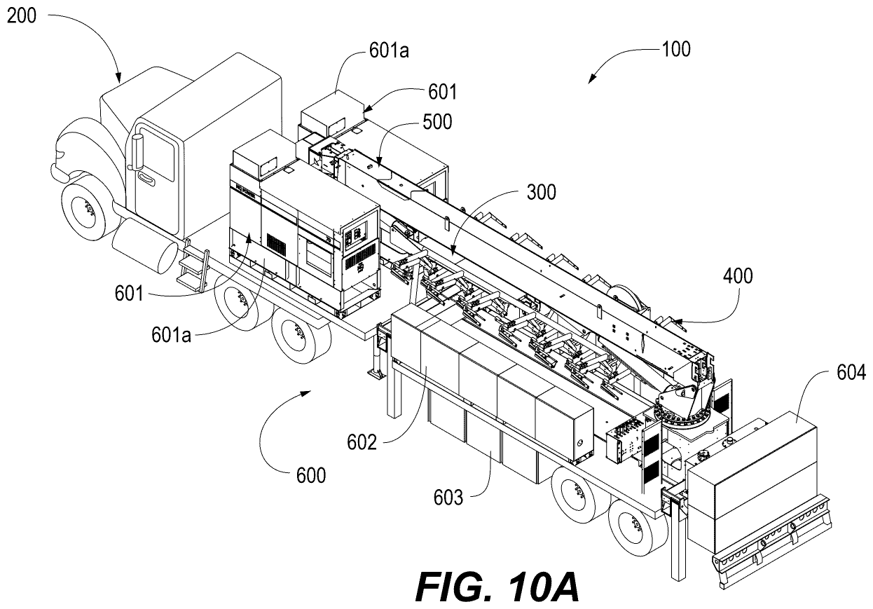

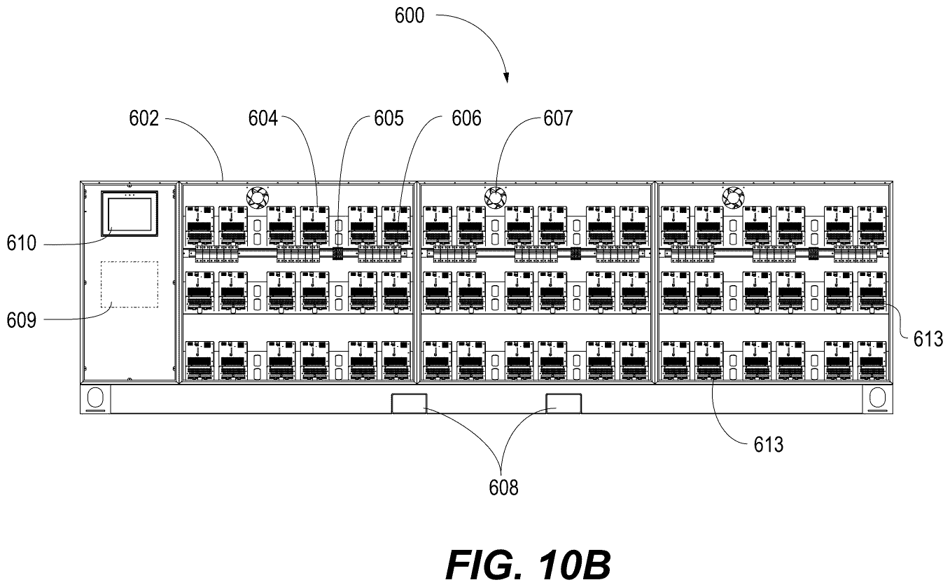

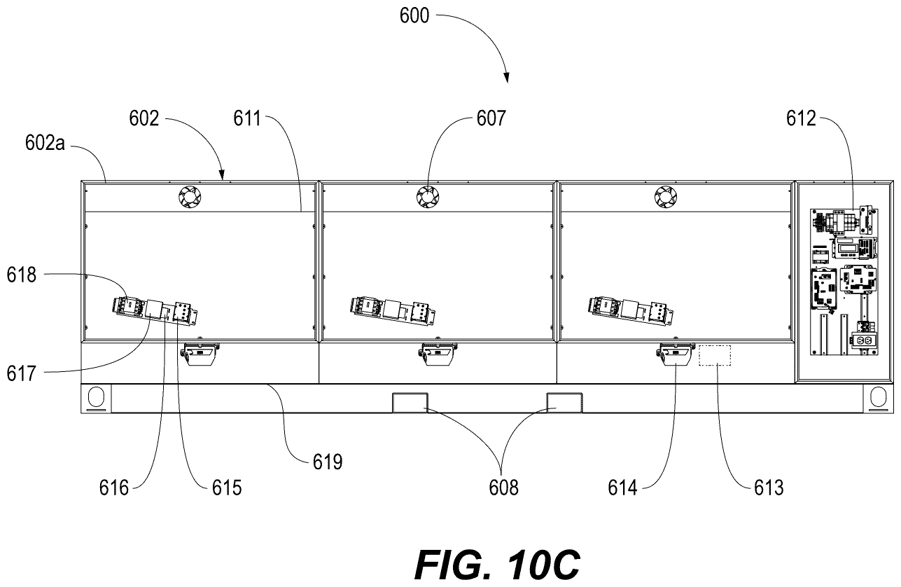

As is perhaps best seen from FIG. 10A, power/storage means 600 includes a number of devices and enclosures 601, 602, 603, 604 designed for various purposes. For example, two generators 605 (e.g., model DCA70SSIU4F available from Multiquip, Inc., Cypress, CA, USA) are employed (e.g., one at front left, one at front right of trailer 210) to ensure available power. However, splitting generators 601 into two portions may thereby (i) allow for center spacing on mobility means 200 for storing boom assembly 500 and jib assembly 300, (ii) ensure more even loading (e.g., weight distribution) on mobility means 200, and (iii) allow for more efficient usage when lighter loads (e.g., having reduced electrical power requirements) are employed (e.g., by running only one generator). Due to the compact nature and reduced space requirements of using two generators 601 in some embodiments, generators 601 may be mounted to trailer 210 via a lockable and releasable mechanism, which allows them to be removed to facilitate performing service thereon.

Generators 601a are used to power, as one example, an electric motor, which when combined with a motor drive package and hydraulic pump, may be employed to power the boom assembly 500 and/or the jib assembly 300. The motor drive package and hydraulic pump used to power boom and jib assemblies 500/300 (as previously discussed) may, for example, be enclosed in enclosure 604. Generators 601a are also used to power control devices contained in enclosures 602, which are used to regulate power to the lighting fixtures (a variety of which are later discussed herein); see FIG. 10B and C. As can be seen in FIGS. 10B and 10C, enclosure 602—which is loaded onto (see apertures 608 for skid loaders) and releasably lockable to trailer 210—has a first side facing outward (i.e., perpendicular to and facing outward from a centerline along the length of mobile lighting system 100)—see FIG. 10B- and a second side, generally opposite to the first side and facing inward-see FIG. 10C.

Looking at the first/outward facing side of enclosure 602 (FIG. 10B), it can be seen a number of drivers 613, terminal blocks 605, and breakers 606 are included to power various lighting fixtures (discussed later); exhaust fans 607 help to manage temperatures in enclosure 602. A first control panel 609 is adapted to operate the lighting fixtures (e.g., on/off controls for light shows) or secondary devices (e.g., cameras used in aiming), and a second control panel 610 may be configured to facilitate movement of various components of rack system 400 (later discussed) remotely. Looking at the second/inward facing side of enclosure 602 (FIG. 10C), it can be seen each cabinet section-which includes a partitioned air path 611 near the top and a recessed wireway 619 near the bottom-includes quick connector halves 614 for wire harnesses and a contactor module subassembly, which generally includes a landing lug 615, quick connect portion 616, current sensor 617, and contactor 618, all of which is controlled by a controller module 612.

Lastly, any number of storage devices 603 (see FIG. 10A) could also be included (e.g., for tools, replacement parts, additional lighting fixtures); these storage devices 603 may, for example, be disposed in one or more locations that are: (i) accessible, yet not impeding foot traffic on mobility means 200, (ii) evenly spaced across both sides of mobile lighting system 100 to ensure even weight balancing/loading, and (iii) not impeding access to fuel tanks located generally on the underside of mobility means 200 (not shown).

### Feature 2—Rack System 400 (for Supporting a Variety of Lighting Fixtures)

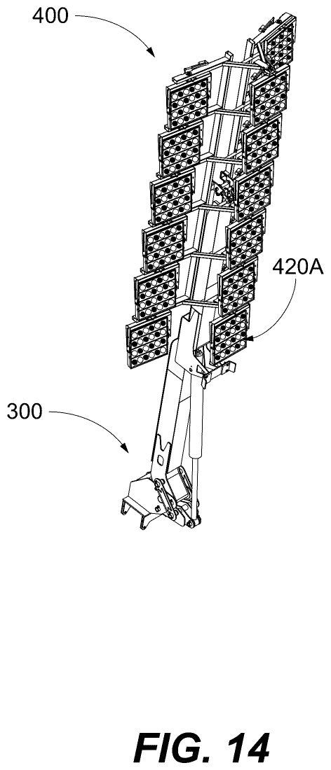

While a variety of lighting fixtures (later illustrated and discussed-see FIGS. 14-16) could be employed to provide a variety of lighting needs (and even special effects according to some embodiments) in mobile lighting system 100, as envisioned each can be operated from a single rack system 400. This reduces the number of parts necessary to store on mobility means 200 while still allowing for a wide range of multi-axis adjustability for devices of varying number and sizes.

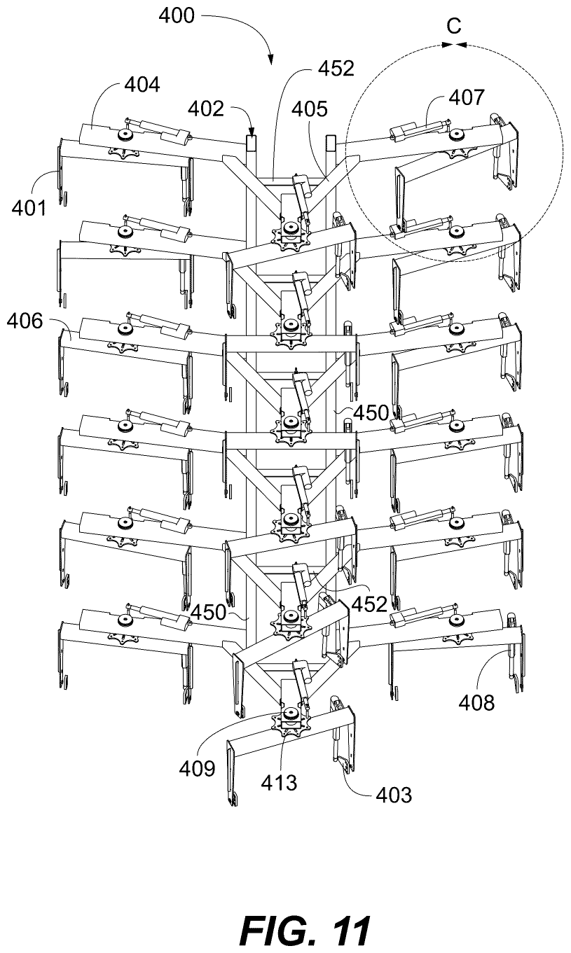

As can be seen from FIG. 11-13, rack system 400 may comprise a backbone portion 402 (may take the form of a ladder type structure in some embodiments of the present disclosure), which may comprise a generally ladder-shaped backbone 402 in embodiments such as that shown in FIG. 11. More specifically as shown in FIG. 11, the ladder or backbone portion 402 may comprise a pair of vertical members 450, and a plurality of horizontal cross-members 452 that connect the pair of vertical members 450 together, providing rigidity. This may not be the case in other embodiments of the present disclosure. For example, the horizontal cross-members may be omitted and/or the vertical members may not be vertical, etc.

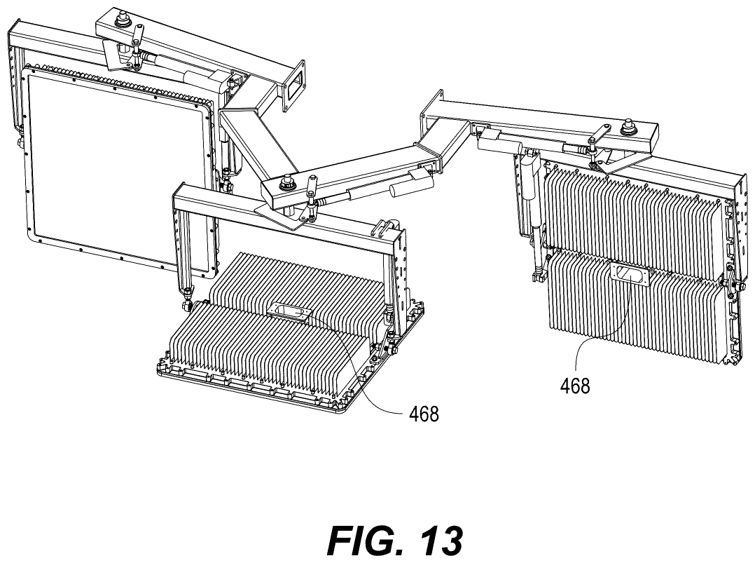

In any case, the backbone portion 402 may be adapted for operative connection to adjustable jib assembly 300, for example, via pinned adapter 304 coupled along backbone portion 402 in some embodiments. Backbone portion 402 may also couple to crossarms 404, and each crossarm 404 may be coupled to a secondary crossarm 405, for example. In some embodiments, a total of 18 lighting fixtures and/or associated harnesses are supported by backbone 402, for example, in six groups of three harnesses. Each group of 3 lighting harnesses may, for example, be offset from one another by approximately 45 degrees—though this could differ in practice and not depart from aspects of the present disclosure. See FIG. 13 for an exemplary arrangement of a grouping of three lighting harnesses and lighting fixtures according to some embodiments of this disclosure.

Power to any devices or lighting fixtures installed on or proximate to lighting rack system 400 may run from generators 601a to control cabinets 602a, covered in protective sleeving (e.g., a flexible nylon-type sleeving or comparable), to rack system 400 where necessary electrical connections are made (e.g., via Phoenix quick connectors available from Allied Electronics & Automation, Fort Worth, TX, USA). Communication lines (e.g., coaxial cable for a wireless antenna installed on rack 400 to enable wireless controls), and pressurized air lines (e.g., to provide active cooling of LED lighting fixtures) may be provided in a similar fashion.

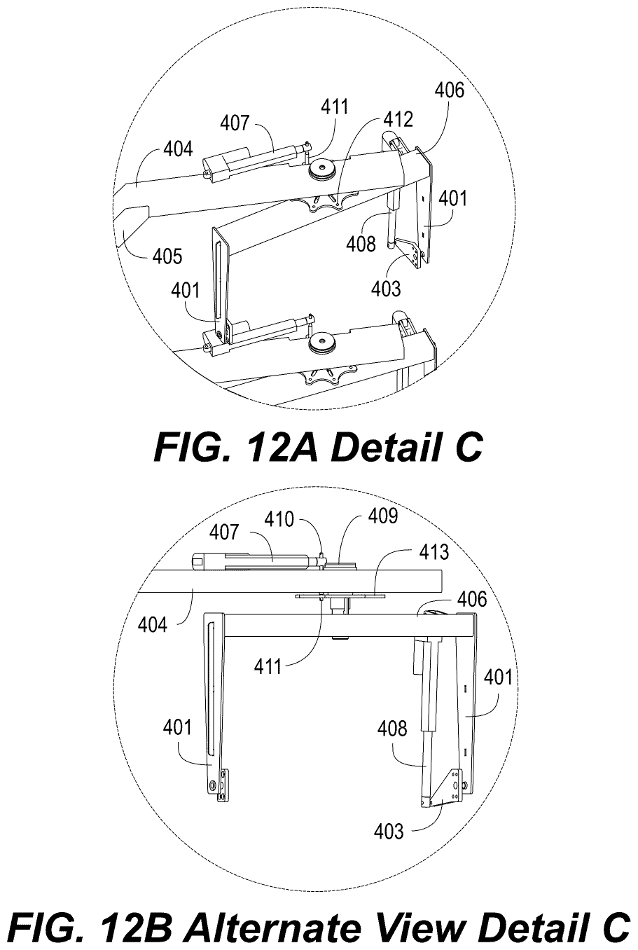

A yoke-style harness, such as that formed by yoke parts (e.g., vertical yoke members 401 and a horizontal yoke member 406) in FIGS. 12A and 12B, may be used to secure in place any size, shape, or type of lighting or special effects fixture or device. In situ adjustment and aiming is provided in a horizontal plane via actuator 409 and keyed plate 413 according to some embodiments. For example, electrical power means 407 may be controlled from an access point on mobility means 200 to allow on the order of 55 degrees of left/right adjustment which is defined by the position of a pin 411 in aperture 412, and therefore, could be adjusted depending on the needs of the application. Likewise, electrical power means 408 allows on the order of from +10 to −80 degrees downward adjustment (i.e., vertical aiming) via structure 403 (may be referred to as rotating attachment bracket which is pinned to harness portion 401). Comparable adjustment of lighting fixtures may be accomplished using the arrangement of electric actuators (may be hydraulic in other embodiments) and gearing shown in FIG. 13, for example. This arrangement allows each of the three lights to be pivoted vertically and horizontally independently from each other, allowing each lighting fixture to face in a different direction. For example, the fixtures may rotate 90 degrees about the horizontal axis, and 180 degrees about the vertical axis for the two side fixtures. The front fixture may only rotate 90 degrees about a horizontal axis, and 120 degrees about a vertical axis in some embodiments of the present disclosure (e.g., as shown in FIG. 13).

### Feature 3—Lighting Apparatuses 420

As has been stated, LEDs come in an array of perceivable colors with near-instant on, off, and dimming capabilities, and LEDs can be paired with other apparatuses (e.g., sound systems) for special effects or otherwise tailored (e.g., in the red/blue spectrum) for lighting effects (e.g., accelerated horticultural growth). A few, non-limiting examples of such-which can be used in applications such as those described in the '471 patent and the '121 publication, or otherwise are presently discussed.

### Feature 3a: Horticultural Lighting

FIG. 14 illustrates a rack system 400 with a plurality of lighting fixtures 420A that may be well-suited for horticultural lighting applications, for example. Additional details on the specific fixture design, including a number of options, alternatives, and additional devices, can be found in the aforementioned '121 publication. Though not discussed herein, it is further contemplated that the LED fireworks simulating fixtures could be employed such as disclosed in U.S. Pat. Appl. Publ. No. 20230164897A1, the contents of which are hereby incorporated herein in its entirety, etc.

### Feature 3b: General Purpose Lighting

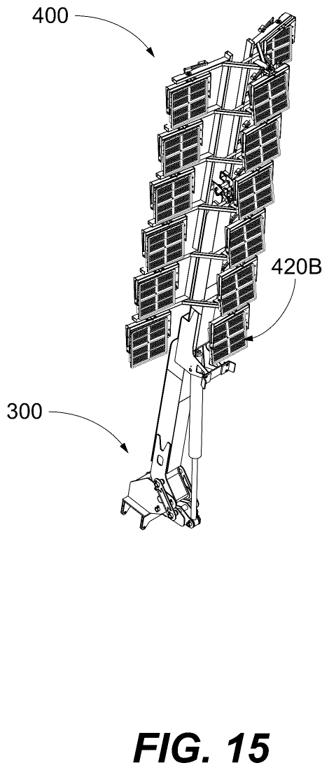

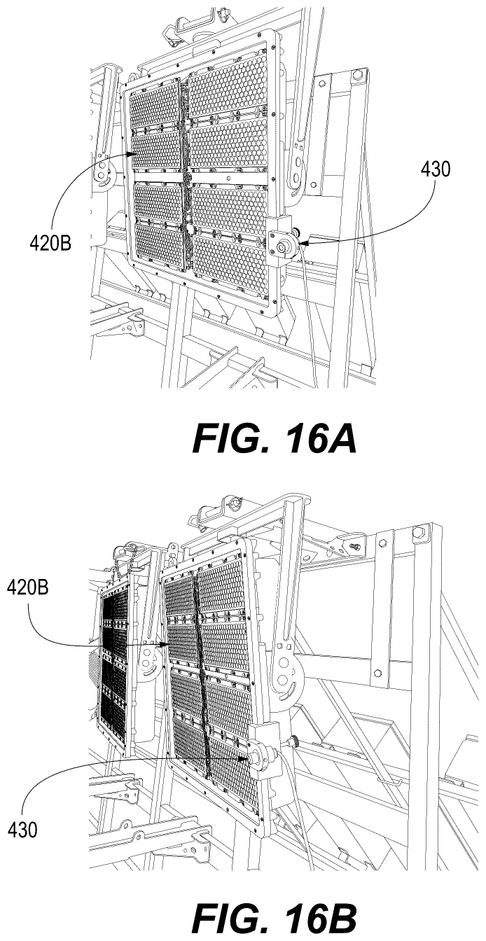

State-of-the-art HID mobile lighting systems, such as those described in the '471 patent, often make use of so-called “6K” HID lamps or lighting fixtures. To approximate a one-to-one replacement for such lighting fixtures using LED lighting technology instead (which may provide certain benefits, such as better color rendering, color effects, expanded dimming, and nearly instant on/off capabilities), another type or design of a lighting fixture is shown as lighting fixture 420B in FIG. 15. Lighting fixture 420B in FIG. 15, for example, may generally comprise a plurality of white LEDs (here, on the order of 990 XM-LM 3 LEDs, available from CreeLED, Inc., Durham, NC, USA), and/or a plurality of RGBA LEDs (here, on the order of 100 of each—also available from CreeLED), which collectively generally operate at a power level of around 600 W in order to produce comparable light output as that of typical state-of-the-art HID lighting systems. If desired, or, for example, if site 20 is located a long distance from staging area 30 (e.g., a temporary installation site), it may be desirable to reduce the overall LED count to make room for narrow beam lenses.

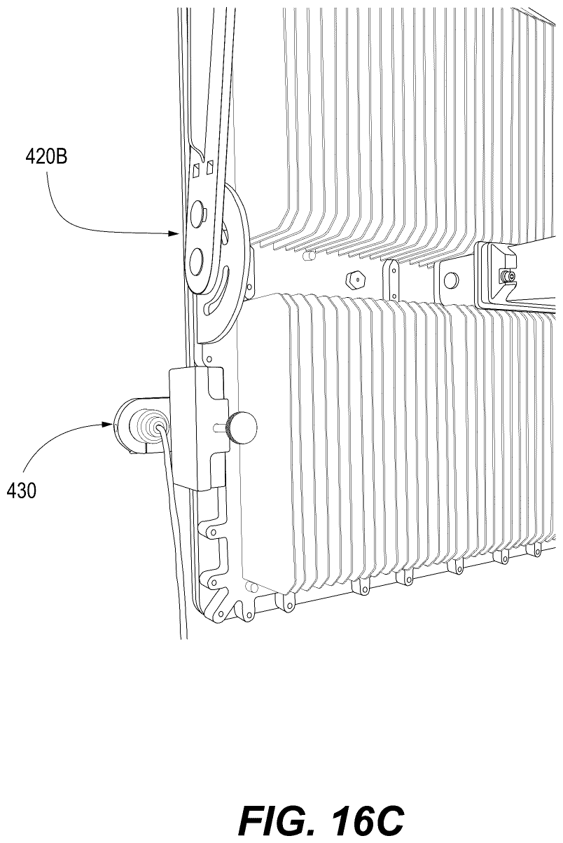

FIG. 16A-16C are images of exemplary LED lighting fixtures 420B, which may be mounted on and/or coupled to rack system 400 of the present disclosure. FIG. 16A provides an enlarged image of a lighting fixture 420B, which may be used according to some embodiments of this disclosure, showing a plurality of LEDs arranged in a generally rectangular and/or square pattern on a surface thereof. (It should be noted that the images in FIG. 16A-16C are intended to show the LED lighting fixtures 420B; however, the lighting fixtures 420B in these images are not coupled to or mounted on a rack system 400 as described in this disclosure.) FIGS. 16A and 16B also show the lighting fixture 420B with a camera 430 releasably coupled thereto. FIG. 16C is a rear perspective view of lighting fixture 420B. Camera 430 may be releasably and/or removably attached to lighting fixture 420B with a knurled thumb screw, for example, as shown in FIG. 16C.

### Feature 4—Aiming, Monitoring, and Feedback Means

As can be appreciated, to provide adequate lighting and/or special effects for a site 20 (e.g., at a stadium, as in FIGS. 1 and 2, or other venue), lighting system 100 may need one, a few, or several components aimed at locations at the site 20. The aiming process may, in some cases, need to be completed prior to fully extending the crane/adjustable boom assembly 500 and/or the jib assembly 300 (e.g., as in FIG. 6). In other cases, the aiming process may need to be performed in situ, while in still other cases, it may be desirable to perform and/or refine aiming of the lighting system 100 both before and after extending the crane/adjustable boom assembly 500 and/or the jib assembly 300. A few, non-limiting examples of how aiming may be achieved are presently discussed.

### Feature 4a: Visual Aiming

Oftentimes, a mobile lighting system 100 such as that illustrated and discussed herein must be positioned well ahead of its intended use. As such, it may be beneficial if such preliminary aiming operations can be performed during daytime (or otherwise lit) hours. To facilitate such aiming, a camera 430 (see FIG. 16A-16C) may be mounted at a known location on rack system 400—this could aid in generally orienting the crane/adjustable boom assembly 500 and/or the jib assembly 300 relative to the expected venue 20. Alternatively, or additionally, one or more individual lighting fixtures (e.g., 420A and/or 420B) could have a camera 430 installed thereupon so that each lighting fixture 420A/420B, for example, could be aimed to a precise point (e.g., by lining up a crosshair of camera 430 to a known location, such as a centerfield mark, for example). Of course, the aforementioned aiming process could also (or alternately) be achieved using video, a laser (e.g., such as that described in U.S. Pat. No. 7,918,586, incorporated by reference herein in its entirety), or by other visual means, and could be wired or wireless according to means already discussed.

### Feature 4b: Sensor-Based Aiming

In some situations, there may be a need for relatively precise aiming of the lighting fixtures 420A, 420B, for example (e.g., color chase sequences, supplemental lighting to even out light levels, etc.). In such circumstances, any number or variety of sensors may be employed to enhance the precision of aiming performed on the lighting fixtures 420A, 420B, for example. Such sensors could be mounted adjacent to individual lighting fixtures 420A, 420B, or to one or more crossarms 404 and/or secondary crossarms 405 of rack system 400, or at one or more positions on boom assembly 500 or jib assembly 300, for example.

### Feature 4c: Wind Detection

As envisioned, at least one possible application of mobile lighting system 100 is to provide horticultural lighting. This may require leaving the mobile lighting system 100 in place for an extended period of time (e.g., many hours, days, etc.). As noted previously, in some embodiments of this disclosure, this might involve de-coupling truck 201 from trailer 210 during such extended period of time. It may be beneficial, in such circumstances, to include an anemometer to detect wind speed at the site 20 (e.g., may be a field, a stadium, etc.) and/or at the staging area 30 so that the crane/adjustable boom assembly 500 and/or the jib assembly 300 may be retracted and the lighting rack system 400 and/or lighting fixtures 420 moved into a stored position (see, e.g., FIG. 3A-3F), at least temporarily, for example, during high wind conditions. In some embodiments, this may involve a notification to a remote operator that a high wind speed condition has been detected. As an example, the anemometer may be associated with a predetermined wind speed threshold that, when exceeded, sends an alert notification to an operator. The operator may then determine if and when to retract the crane/adjustable boom assembly 500 and/or the jib assembly 300, for example. In other embodiments, a predetermined wind speed threshold may, when exceeded and/or detected by the anemometer, automatically trigger the retraction of the crane/adjustable boom assembly 500 and/or the jib assembly 300, for example.

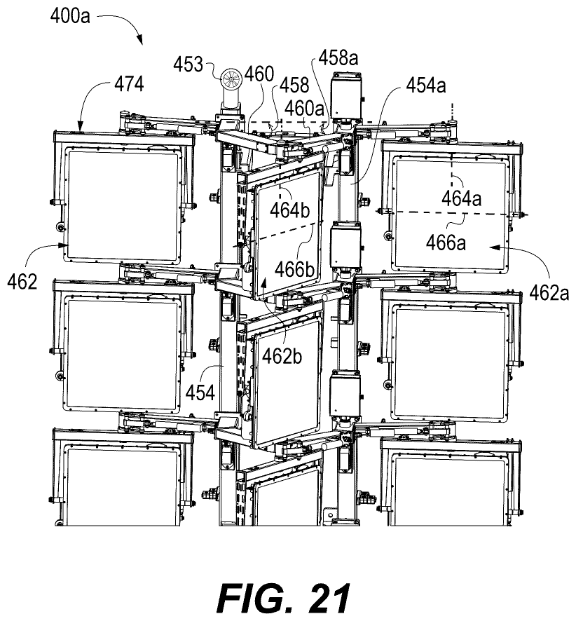

In addition, an anemometer or other weather gauge 453 (see FIG. 21) may be attached to the lighting rack, the jib, or the boom and connected to the operating system to alert the operator or to cause automatic retraction or adjustment of the lighting rack, the jib, or the boom if a wind speed is exceeded or other adverse weather condition is detected, etc.

### C. Exemplary Apparatus Embodiment 2

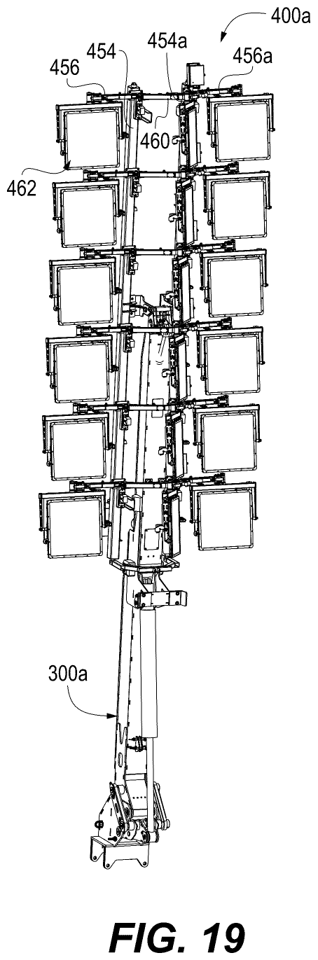

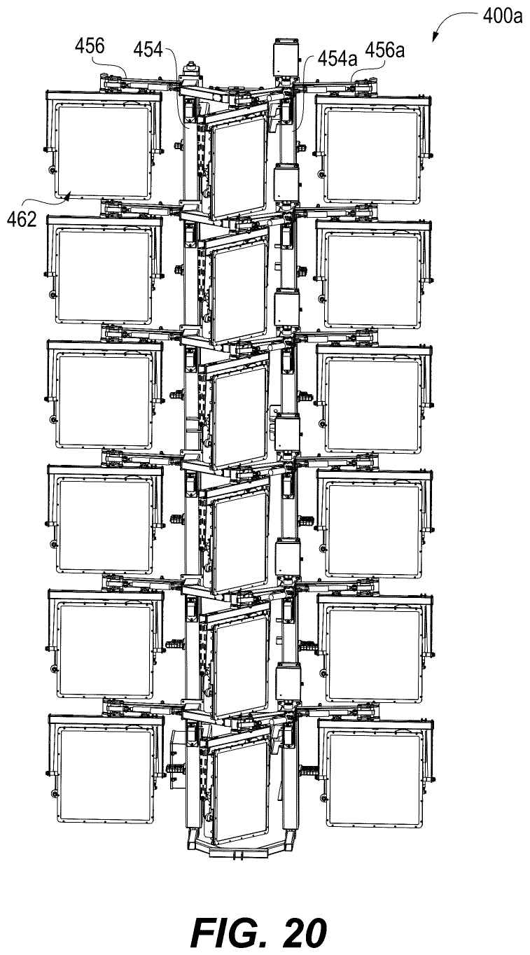

Another embodiment that includes any of the features previously described herein albeit with various modifications will now be discussed with reference to FIG. 19 thru 23.

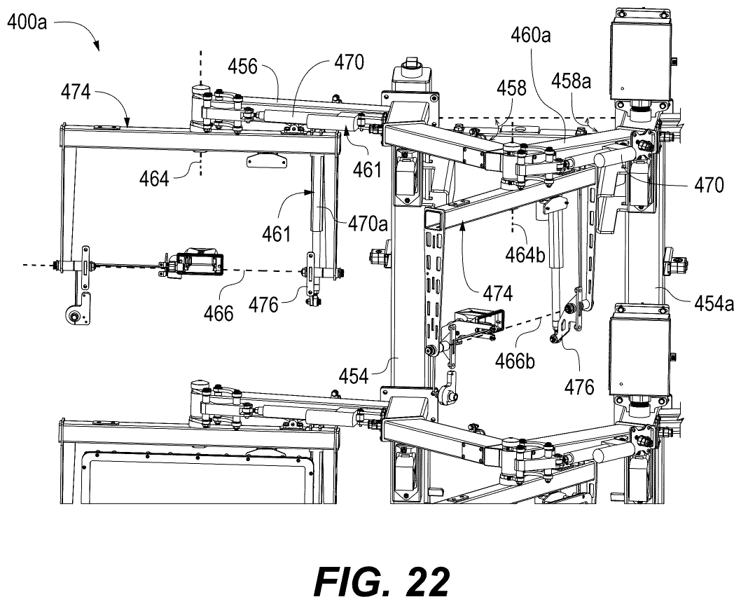

Starting with FIG. 19 thru 21, another embodiment of the lighting rack may be described as follows. Such a lighting rack 400a may comprise a first vertical member 454 and a second vertical member 454a, a first crossarm 456 extending from the first vertical member 454, a first secondary crossarm operably 460 operably connecting the first crossarm 456 to the second crossarm 456a that extends at a first oblique angle 458 in a horizontal plane (e.g., plane that is perpendicular to first vertical member) relative to the first crossarm 456 (see also FIG. 22), a first LED light fixture 462 (e.g., a first side LED light fixture) operably connected to the first crossarm 456, and an actuation means 461 (see FIG. 22) for rotating the first LED light fixture about a first vertical axis 464 (may be referred to as yaw) and a first horizontal axis 466 (may be referred to as pitch). Also, a second crossarm 456a may extend from the second vertical member 454a at a second oblique angle 458a (see FIG. 22)in the horizontal plane relative to a second secondary crossarm 460a.

The actuation means may be electric (e.g., via an electric linear actuator 470 such as a solenoid, etc.) or hydraulic, etc.. Also, electrical power means 468 (e.g., an electrical socket and inherent wiring associated therewith, see FIG. 13) may be provided to turn the lights on, etc.

In some embodiments as shown in FIGS. 21 and 22, the first oblique angle ranges from 30 degrees to 60 degrees, as well as the second oblique angle. More precisely, each of these angles may be about 45.0 degrees (+/−5.0 degrees) to allow the proper orientation and spacing to maximize the movement of the light fixtures.

Similarly, as seen in FIGS. 21 and 22, a second LED light fixture 462a (e.g., a second side light fixture) may be provided that is operably connected to the second crossarm 456a about a second vertical axis 464a and a second horizontal axis 466a having the same ranges of rotation. Specifically, the first LED light fixture 462 may be configured to rotate at least 175.0 degrees about the first vertical axis 464, and at least 85.0 degrees about the first horizontal axis 466, while the second LED light fixture 462a may be configured to rotate at least 175.0 degrees about the second vertical axis 464a, and at least 85.0 degrees about the second horizontal axis 466a. The goal may be to achieve at least 90.0 degrees and 120.0 degrees of rotation in some embodiments of the present disclosure.

Still referring to FIGS. 21 and 22 together, a third LED light fixture 462b may be operably connected to the first secondary crossarm 460 and/or the second secondary crossarm 460a that is configured to rotate at least 115.0 degrees about a third vertical axis 464b and at least 85.0 degrees about a third horizontal axis 466b in some embodiments of the present disclosure.

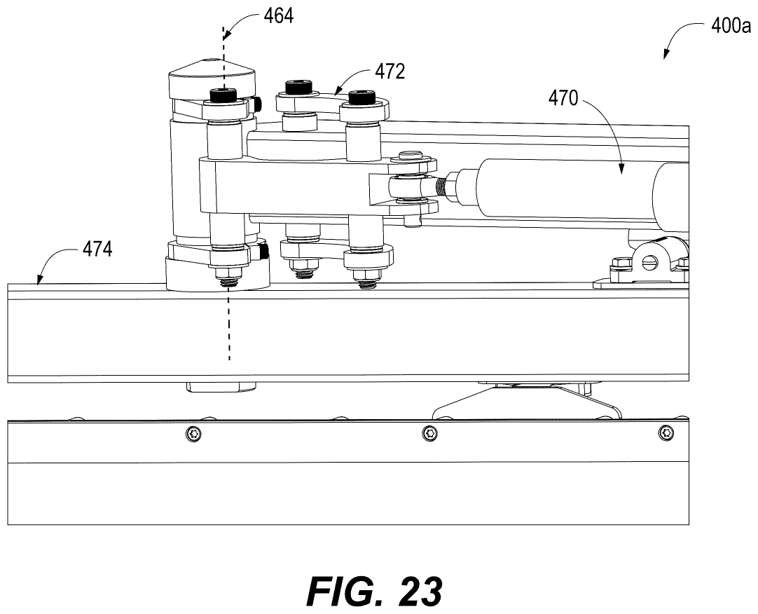

As best seen in FIG. 23, the first electric linear actuator 470 may be operably connected to a first keyed plate as previously described herein or a rotatable linkage mechanism 472 that is attached to a yoke 474 for rotating the first LED light fixture 462 about the first vertical axis 464. Also, as seen in FIG. 22, a electric linear actuator 470 may be connected to the yoke 474 (e.g., via a rotating attachment bracket 476) for rotating the first LED light fixture 462 about the first horizontal axis 466. Similar descriptions may be given concerning the second and third instances of the lighting fixtures, yokes, etc. The first, second, and third instances may be repeated to form a vertical array of lights, but not necessarily so.

The crossarms may be bolted onto the vertical members of this embodiment of the lighting rack, allowing them to be removed or added more easily than the earlier embodiment where welding was employed. Also, as alluded to earlier herein, the light fixtures are movable enough that manual detachment and reattachment may not be necessary.

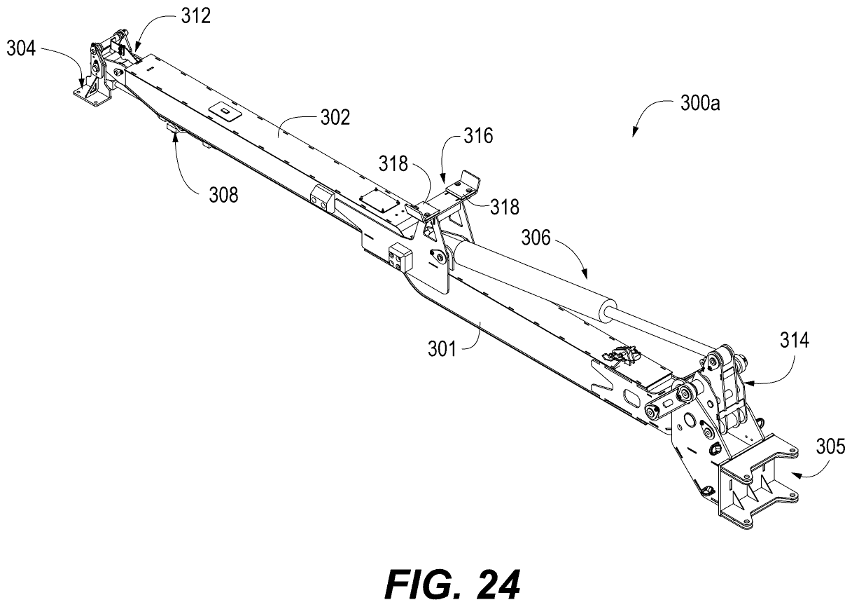

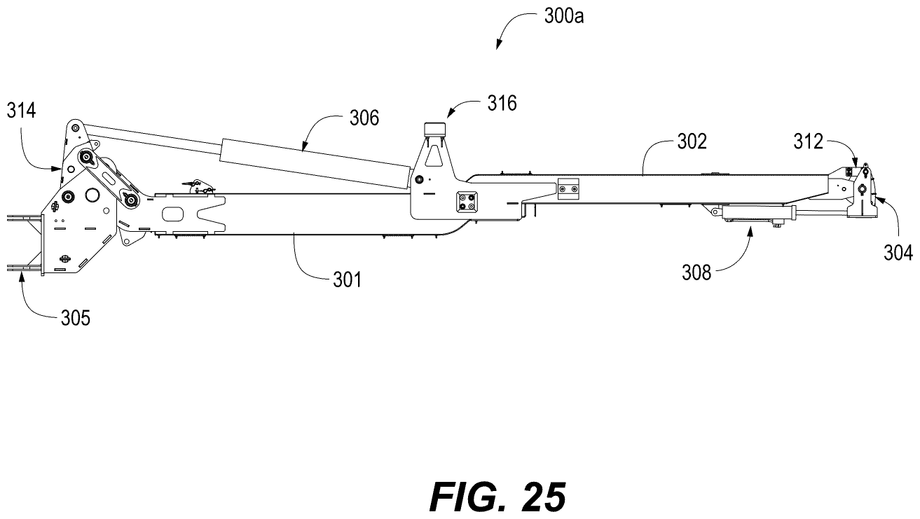

Turning now to FIGS. 24 through 27, another embodiment of a jib assembly 300a that is similar to or identical to jib assembly 300 discussed earlier herein will now be discussed. Hydraulic cylinders 306 and 308 are employed to move the jib assembly for a stored to a transportation state, but is contemplated that other means for moving the jib could be employed such as electric, etc. Also, these cylinders have a longer throw, requiring the attachment points of the cylinders to be altered so their relative placement and orientation to the first member 301 and the second member 302 have changed. Also, the lengths of the first member and second member may be longer than previously disclosed herein.

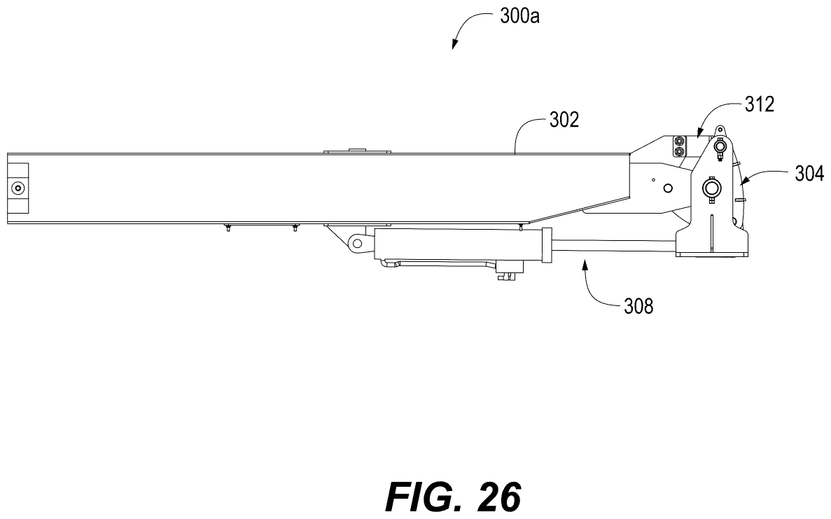

More specifically, FIG. 26 shows that hydraulic cylinder 308 is essentially parallel to and spaced away from the second member 302 as compared to the earlier embodiment since it is attached and downward extending bracket 310 toward the pinned adapter 304 used for attachment to the light rack. A stop plate 312 that multiplies the force as the hydraulic cylinder 308 moves the pinned adapter 304 is now more clearly shown than in the earlier embodiment as well.

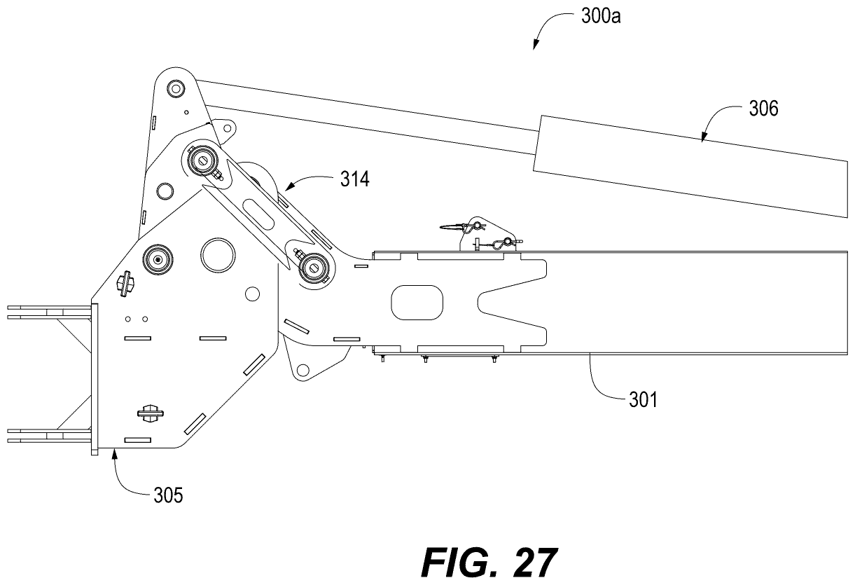

Likewise, FIGS. 24 and 27 illustrate that the hydraulic cylinder 306 extends from a spacer bracket 316 toward a large toggle mechanism 314 that also multiplies the force as the hydraulic cylinder 306 moves the pinned adapter 305 used to attach the jib assembly to the boom. The spacer bracket is so called since it provides a buffer between the jib assembly and the boom when in the transportation mode, helping to prevent damage as the jib assembly contacts the boom. To that end, cushion member(s) 318 may be provided as well if desired. The spacer bracket may have a U-shaped member to help the jib assembly properly locate the boom as it approaches the boom and prevent lateral swaying.

Referring now to FIGS. 3C to 3E, a counterbalance 230 in the form of weight holders may be disposed between a pair of rear wheel axles 232 disposed adjacent a rear of the mobility means 200. For example, the truck may be 10 feet longer than previously so suspended weight may help to provide counterbalance and prevent tipping. Also, at least one footing holder (generally shown by 232) may be attached to the mobility means 200, and a distribution box may be disposed near a front of the mobility means 200.

### INDUSTRIAL APPLICABILITY

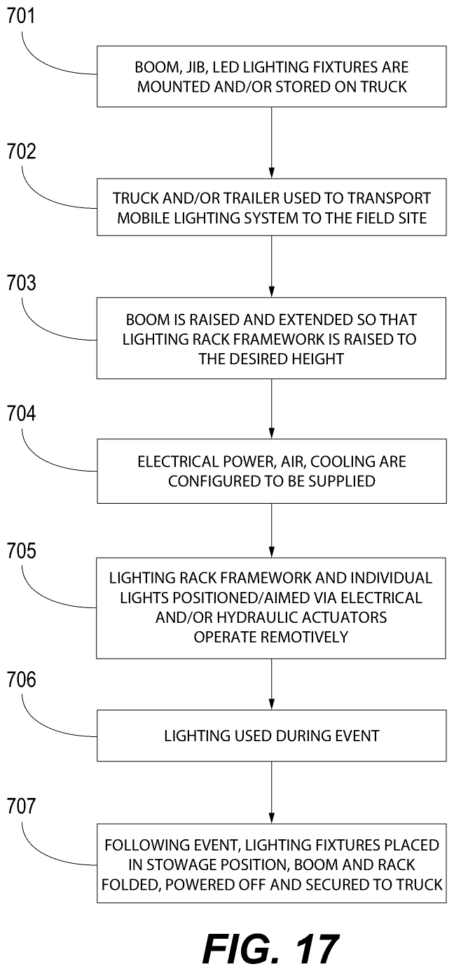

FIG. 17 is a flowchart diagram illustrating an exemplary method for using a mobile lighting system 100 according to some embodiments of this disclosure.

Step 701, for example, describes a step of mounting and/or storing various components of lighting system 100 onto trailer 210 and or truck 201. For example, boom assembly 500, jib assembly 300, lighting rack system 400, and LED lighting fixtures 420 may be mounted or stored on trailer 210 in a secure, folded configuration, also referred to herein as a transport mode or configuration. This may include, as possible examples, jib assembly 300 and lighting rack system 400 being folded beneath boom assembly 500, then being positioned between rows of side enclosures 602 of power storage means 600, and then secured to the trailer 210 via one or more stability points 205, according to some embodiments.

Step 702, for example, describes the step of using the truck 201 to transport the mobile lighting system 100 to the site 20 and/or to the staging area 30.

In step 703, the boom assembly 500 is raised and/or extended so that lighting rack system 400 is raised to the desired height and positioned appropriately. Step 703 may further include, for example, actuation of jib assembly 300 to facilitate positioning of rack system 400.

Step 704 includes establishing any electrical power, hydraulic, air, and/or cooling connections and flow paths desired for operation of lighting system 100.

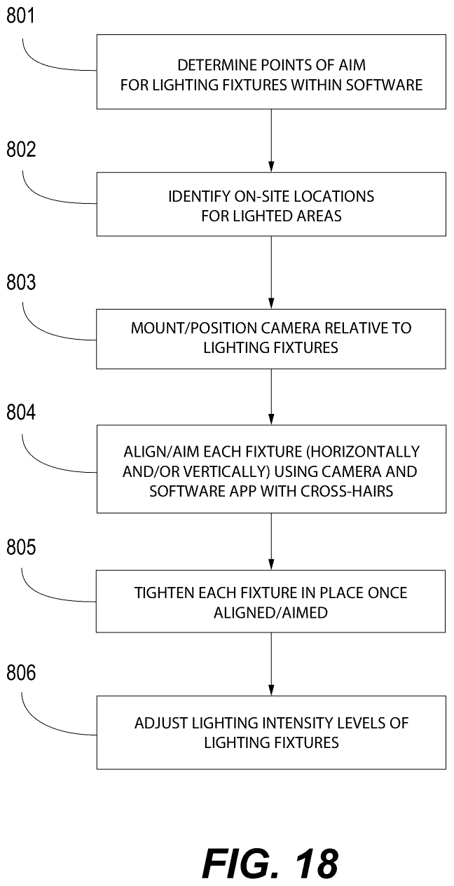

Step 705 describes positioning the lighting rack system 400, as well as adjusting the positioning and/or aiming of individual lighting fixtures 420 via remote actuation of hydraulic and/or electrical controls. In some embodiments, one or more hydraulic cylinders may be operated remotely to effectuate tilting of lighting rack system 400 and/or individual lighting fixtures 420 to the desired positions and/or angles. For the individual lighting fixtures 420, this may include a certain degree of rotation in a horizontal plane (e.g., rotation about a generally vertical axis to pan left or right), as well as a certain degree of rotation or tilting in a vertical plane (e.g., tilting about a generally horizontal axis to tilt up or down). Additional details on a process for aiming of individual lighting fixtures is provided below with reference to FIG. 18.

Step 706 describes using the lighting system 100 to provide lighting during the event at site 10 or venue 20, for example.

Finally, step 707 describes, in general terms, powering off the electrical, hydraulic, air, and/or cooling systems used during the event, and placing certain components of lighting system 100 (e.g., rack system 400 and associated lighting fixtures 420, jib assembly 300, and boom assembly 500) back into the folded and secured storage positions (e.g., transport mode) on trailer 210. Truck 201 may also be coupled to trailer 210 at this point, according to certain embodiments of this disclosure.

FIG. 18 is a flowchart diagram with additional details or sub-method steps associated mainly with step 705 of FIG. 17. For example, FIG. 18 illustrates steps of an exemplary method for aiming one or more lighting fixtures 420 of a mobile lighting system 100, according to some embodiments of this disclosure.

Step 801, for example, describes an initial step of determining points of aim for the individual lighting fixtures 420. This step may, for example, be accomplished by an operator (e.g., an applications engineer in some embodiments) using software to establish one or more points of aim for a particular lighting fixture 420.

Step 802, for example, involves identifying one or more on-site aiming locations to which the lighting fixtures 420 will be aimed.

Step 803 involves releasably mounting a camera 430 to each lighting fixture 420 to be aimed at an on-site location.

Step 804 describes a step of using the camera 430 in conjunction with a software application (e.g., running on a handheld, tablet, or smartphone device, for example) that allows each lighting fixture to be tilted (horizontally and/or vertically) to align camera “crosshairs” (e.g., viewable on the software application) for each fixture to the desired on-site aiming location. The lighting fixtures 420 are tilted by remote control of hydraulic or electrical actuators, in some exemplary embodiments of this disclosure.

In step 805, after each lighting fixture 420 has been aimed, it is then secured and/or tightened in place for use during the lighting event. This might not be necessary for embodiments such as discussed above regarding the second embodiment of the apparatus since positioning of the light fixtures is automated and it is not necessary to unpin, reposition the light fixture, and then repin, etc.

Step 806 involves adjusting the lighting intensity level of one or more of the lighting fixtures (e.g., increase or decrease the intensity) to suit the needs of the particular lighting event.

Certain other related technologies, which may be beneficial to the operation and control of the mobile lighting system 100 of this disclosure are described in, for example, U.S. Pat. No. 9,026,104 (“Means and Apparatus for Control of Remote Electronic Devices”) and U.S. Pat. No. 9,964,267 (“Apparatus, Method, and System for Tilted Pole Top Fitter”), the contents of both of which are incorporated by reference herein in their respective entireties.

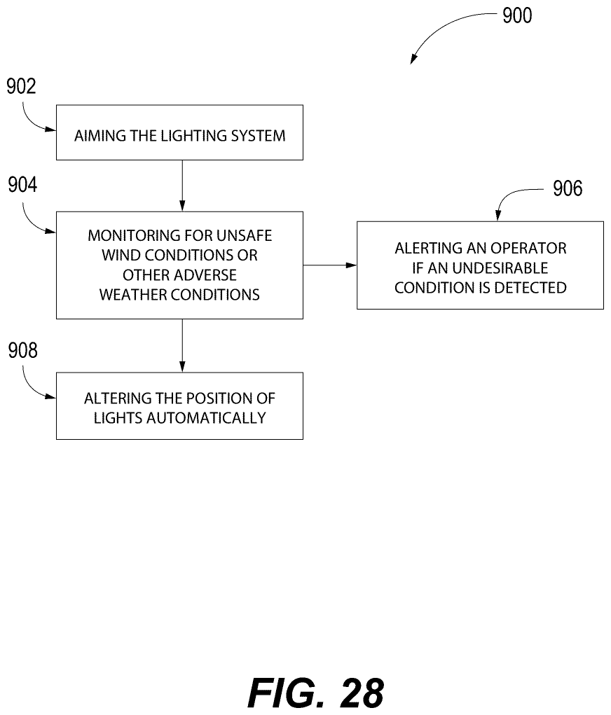

Another method for controlling a mobile light system is depicted in FIG. 28. Such a method 900 may comprise aiming the lighting system (see step 902) or monitoring for unsafe wind conditions or other adverse weather conditions (step 904). Put more generally, step 904 may include monitoring for any undesirable operating condition. If an undesirable operating condition is detected, the operator may be alerted (see step 906). In addition or in lieu of step 906, the operating system may automatically alleviate the condition (e.g., by altering the position of the lights, see step 908).

### D. Options and Alternatives

Variations and alternate configurations of this disclosure may take many forms and embodiments. The foregoing examples are but a few of those. To give some sense of some options and alternatives, a few examples are given below.

While mobile lighting system 100 has been illustrated as a fully mobile system with mobility means 200, it is important to note that system 100 need not be fully mobile. Particularly for long-term lighting applications (e.g., horticultural lighting), it may be beneficial for lighting system 100 to simply be dropped off at a temporary installation site 30; in this sense, mobility means 200 may still include a vehicle (e.g., truck 201), but one which detaches or decouples and is removed from the rest of mobile lighting system 100 during installation (e.g., leaving trailer 210 to support remainder of lighting system 100 in some embodiments).

Also, while a number of LED lighting fixtures 420 have been illustrated, and a number of options, features, and alternatives have been discussed in the Appendices, it is important to note that none of these are to be considered limiting. While LEDs as a lighting technology offer many benefits over more traditional HID lighting, aspects of the present disclosure might also be applied to other types of light sources (e.g., lasers)-for example, to provide theatrical effects.

What is claimed is:

1. A mobile lighting system for illuminating an area, the mobile lighting system comprising: a mobile support system configured to be transported to a lighting location by a motorized vehicle portion detachably coupled thereto;
a boom portion having a first end and a second end, the first end pivotally mounted to the mobile support system along a horizontal axis;
a jib portion operably coupled to the second end of the crane portion;
a lighting rack operably coupled to the jib portion, the lighting rack comprising an array of LED lighting components;
a hydraulic system disposed on a supported surface of the mobile support system, the hydraulic system aligned generally parallel to the longitudinal axis of the mobile support system, the hydraulic system configured to move the boom portion and the jib portion from a transportation mode of the mobile lighting system to a deployed mode of the mobile lighting system; and
an electrical power system disposed on the supported surface of the mobile support system, the electrical power system configured to provide electrical power to at least the array of LED lighting components of the lighting rack;
wherein at least a portion of the hydraulic system or the electrical power system are housed within two rows of cabinets mounted on the supported surface of the mobile support system on either side of the generally longitudinal axis of the mobile support system; and
wherein the transportation mode comprises the jib portion and the lighting rack being disposed beneath the boom portion in a generally horizontal configuration, the jib portion, the lighting rack, and the boom portion being positioned between the two rows of cabinets mounted on the supported surface of the mobile support system to provide support and protection thereto.

2. The mobile lighting system of claim 1, wherein the two rows of cabinets define a corridor therebetween, and the lighting rack is at least partially disposed in the corridor.

3. The mobile lighting system of claim 1, wherein the lighting rack is configured such that the array of LED lighting components includes a plurality of LED light fixtures that are capable of rotating about a horizontal at least 90 degrees, and about a vertical axis of at least 120 degrees.

4. The mobile lighting system of claim 3, wherein the plurality of LED light fixtures are capable of rotating about a vertical axis of at least 180 degrees.

5. The mobile lighting system of claim 1, wherein the array of LED lighting components includes a plurality of LED light fixtures that each have a camera attached thereto for aiming.

6. The mobile lighting system of claim 1, further comprising an anemometer that is attached to the lighting rack, the jib, or the boom.

7. The mobile lighting system of claim 1, further comprising a counterbalance disposed between a pair of rear wheel axles disposed adjacent a rear of the mobile support system.

8. The mobile lighting system of claim 1, further comprising at least one footing holder attached to the mobile support system.

9. The mobile lighting system of claim 1, further comprising a distribution box disposed near a front of the mobile support system.

10. A lighting rack for a mobile lighting system, the lighting rack comprising:
a first vertical member and a second vertical member;
a first crossarm extending from the first vertical member;
a second crossarm extending from the second vertical member;
a first secondary crossarm operably connecting the first crossarm to the second crossarm that extends at a first oblique angle in a horizontal plane relative to the first crossarm;
a first LED light fixture operable connected to the first crossarm; and
an actuation means for rotating the first LED light fixture about a first vertical axis and about a first horizontal axis.

11. The lighting rack of claim 10, wherein the first oblique angle ranges from 30 degrees to 60 degrees.

12. The lighting rack of claim 10, wherein the actuation means includes electric actuation means and further comprising electrical power means for lighting the first LED light fixture.

13. The lighting rack of claim 10, further comprising a second LED light fixture that is operably connected to the second crossarm about a second vertical axis and a second horizontal axis.

14. The lighting rack of claim 13, wherein the first LED light fixture is configured to rotate at least 175.0 degrees about the first vertical axis, and at least 85.0 degrees about the first horizontal axis, and the second LED light fixture is configured to rotate at least 175.0 degrees about the second vertical axis, and at least 85.0 degrees about the second horizontal axis.

15. The lighting rack of claim 14, further comprising a third LED light fixture that is operably connected to the first secondary crossarm that is configured to rotate at least 115.0 degrees about a third vertical axis and at least 85.0 degrees about a third horizontal axis.

16. The lighting rack of claim 15, wherein the actuation means includes a first linear electric actuator that is operably connected to a first keyed plate or a first rotating linkage mechanism that is attached to a yoke for rotating the first LED light fixture about the first vertical axis.

17. The lighting rack of claim 16, wherein the actuation means further includes a second linear electric acutator that is connected to the yoke for rotating the first LED light fixture about the first horizontal axis.

18. The lighting rack of claim 15, wherein the first LED fixture, the second LED fixture, and the third LED fixture are part of a vertical array of LED fixtures.

19. A method of controlling a mobile lighting system, the method comprising:
aiming the lighting system; and
monitoring for unsafe wind conditions or other adverse weather conditions.

20. The method of claim 19, further comprising altering the position of lights automatically.
